(19) United States
(12) Patent Application Publication
(10) Pub. No.: US 2015/0086865 A1
(43) Pub. Date: Mar. 26, 2015

(54) POSITIVE ELECTRODE FOR SECONDARY BATTERY, SECONDARY BATTERY, AND METHODS FOR MANUFACTURING THE SAME

(71) Applicant: NEC ENERGY DEVICES, LTD., Sagamihara-shi, Kanagawa (JP)

(72) Inventor: Noriaki Oda, Kanagawa (JP)

(73) Assignee: NEC ENERGY DEVICES, LTD., Sagamihara-shi, Kanagawa (JP)

(21) Appl. No.: 14/394,291

(22) PCT Filed: Apr. 12, 2013
(86) PCT No.: PCT/JP2013/061026

§ 371 Date: Oct. 14, 2014

(30) Foreign Application Priority Data
May 14, 2012 (JP) 2012-110722

(51) Int. Cl. H01M 4/131; H01M 4/04; H01M 4/525; H01M 10/0525; H01M 4/485; H01M 4/505

(52) U.S. Cl. CPC H01M 4/131; H01M 4/485; H01M 4/505; H01M 4/525; H01M 10/0525; H01M 4/0433; H01M 2004/028
USPC 429/211; 429/223; 429/224; 429/231.3; 29/623.5; 264/104

(57) ABSTRACT

The present invention provides a positive electrode for a secondary battery that can suppress a phenomenon in which, after the solid electrolyte interface is formed once, when a damaged portion where a solid electrolyte interface is partially broken happens to arise in the solid electrolyte interface, the continued deterioration in the performance of charge-discharge cycle of the secondary battery is induced thereby, and a secondary battery using said positive electrode for a secondary battery. The positive electrode for a secondary battery according to the present invention comprises water that is chemically adsorbed beforehand in the positive electrode, wherein the concentration of the chemically adsorbed water, which is comprised in the positive electrode beforehand, is set in the range of 0.03% by mass to 0.15% by mass based on the positive electrode.

### TECHNICAL FIELD

The present invention relates to a positive electrode for a secondary battery, a secondary battery, and methods for manufacturing the same, and particularly to a positive electrode for a secondary battery that can repair a damaged solid electrolyte interface in a self-aligning manner during operation, a secondary battery using it, and methods for manufacturing the same.

### BACKGROUND ART

Ion secondary batteries have following advantages that their energy density is high, they are less likely to undergo self-discharge, and they are free from memory effect. Because of the advantages, in recent years, the use of lithium ion secondary batteries has expanded steadily as power supplies for consumer mobile equipment such as cellular phones, notebook computers, and PDAs, and further electric vehicles, hybrid vehicles, electric bicycles, electric motorcycles, and home storage batteries.

In a lithium ion secondary battery, a positive electrode and a negative electrode are stacked with a separator intervening between them, and an electrolytic solution fills therein to compose the secondary battery. The entire lithium ion secondary battery is placed in a package comprised of aluminum laminate film or the like, and a tab for a positive electrode comprising aluminum as a main material is attached to the positive electrode, and a tab for a negative electrode comprising nickel as a main material is attached to the negative electrode. The tab for a positive electrode and the tab for a negative electrode are extracted to the outside of the package to form connection terminals to an external circuit.

In the lithium ion secondary battery, a nonaqueous electrolytic solution is used, and the nonaqueous electrolytic solution is comprised of a lithium salt, which is a supporting electrolyte, and a nonaqueous organic solvent. The lithium salt, which is used as a supporting electrolyte, is dissociated in the nonaqueous organic solvent. The nonaqueous organic solvent is required to have a high dielectric constant, attain high ion conductivity in a wide temperature region, and be stable in the secondary battery. A slight amount of water is accidentally mixed into the nonaqueous electrolytic solution during its preparation process. The water that is comprised in the nonaqueous electrolytic solution reacts with the lithium salt (for example, LiF.PF₅ or LiF.BF₃) to give hydrogen fluoride (HF) during the first charge process. In addition, LiF, which is a residual component resulting therefrom, is deposited on the negative electrode to form a solid electrolyte interface (SEI). It is known that the formation of this solid electrolyte interface which is comprised of LiF stabilizes cell performance, its cycle performance.

For example, in a lithium ion secondary battery disclosed in Patent Document 1, a coating layer formed of LiF-based particles is formed with a thickness of 0.05 μm to 1 μm on the surface of the negative electrode. In the case disclosed in Patent Document 1, in order to stably form said SEI layer, such a procedure is used in which a negative electrode is immersed in an electrolytic solution where LiPF₆ is dissolved in a carbonate-based organic solvent, to compose a two-electrode electrochemical cell or a three-electrode electrochemical cell, and then, voltage is applied to the electrochemical cell in an atmosphere containing 50 ppm by weight to 2000 ppm by weight of water. In addition, it is reported that a slight amount of water that is originally comprised in the nonaqueous electrolytic solution, and manufacturing the negative electrode in an atmosphere containing moisture are more effective for coating layer formation on the surface of the negative electrode (Patent Document 1).

In addition, Patent Document 2 discloses a nonaqueous electrolytic solution comprising 0.03 to 0.7% by mass of hydrogen fluoride based on the total of a nonaqueous organic solvent and a supporting electrolyte, and 0.01 to 4.0% by mass of a compound having a carboxyl group or a carboxylic anhydride group based on the total of the nonaqueous organic solvent and the supporting electrolyte, and a lithium ion secondary battery using the nonaqueous electrolytic solution. Hydrogen fluoride is added to the nonaqueous electrolytic solution, and as methods for adding it, a method of directly blowing hydrogen fluoride gas into the nonaqueous electrolytic solution, and a method of adding water to the nonaqueous electrolytic solution to produce hydrogen fluoride in the nonaqueous electrolytic solution are disclosed (Patent Document 2). In the latter method, hydrogen fluoride is produced using the reaction of water and the supporting electrolyte of the following formula (1).

LiMFₙ+H₂O→LiMF₍ₙ₋₂₎O+2HF formula (1)

wherein M represents an element such as P or B, and when M=P, n=6, and when M=B, n=4.

Further, in a lithium ion secondary battery disclosed in Patent Document 3, a porous film that is comprised of a thermoplastic resin containing an inorganic filler is used as the separator, and water that is comprised in the secondary battery is adjusted to concentration of 200 to 500 ppm (0.02 to 0.05% by mass) based on the nonaqueous electrolytic solution. It is reported that by controlling the contained water in the above range, the electrode interface resistance can be kept low. A factor that decreases the electrode interface resistance is presumed to be the contribution of a “by-product (contributing substance)” produced in the reaction of the lithium salt used as the supporting electrolyte and water. The lower limit value of the concentration of the contained water is defined for the purpose of setting the amount of the produced “contributing substance” that is effective for the decrease in electrode interface resistance described above to a level essential for attaining an effect on “the decrease in electrode interface resistance”.

On the other hand, when the water that is comprised in the secondary battery increases and exceeds the aforementioned upper limit value of the concentration of the contained water, capacity decrease that is caused by deterioration in the electrode electroactive substance (for example, the positive electrode electroactive substance) which is induced by hydrofluoric acid (HF) produced in the reaction of the lithium salt used as the supporting electrolyte and water is significant, which is not preferred. It is indicated that the water that is comprised in the secondary battery originates mainly from water adhering to the electrode materials and the separator. The method for measuring the amount of water adhering to the electrode materials and the separator is defined as follows.

For the amount of water that is comprised in the electrode materials and the separator, a measurement sample is placed in a 130° C. heating furnace in which nitrogen gas is flowed, and held for 20 minutes. The flowed nitrogen gas is introduced into the measurement cell of a Karl Fischer aquameter, and the amount of water is measured therein. The accumulated value for 20 minutes is defined as the total amount of the contained water. The measurement is carried out in a glove box having dew point of −75° C. in order to prevent the mixing of the surrounding water.

In addition, the amount of water that is comprised in the nonaqueous electrolytic solution is measured as follows. In the nonaqueous electrolytic solution, the Li salt, which is used as the supporting electrolyte in the electrolytic solution, and a small amount of water react rapidly to produce hydrofluoric acid (HF). Therefore, for example, it is possible to quantify HF in the nonaqueous electrolytic solution by acid content measurement and calculate the amount of water which was comprised in the nonaqueous electrolytic solution from the value measured for HF.

### PRIOR ART DOCUMENT

### Patent Document

### Patent Document 1: JP2011-513912A

### Patent Document 2: JP4662600B

### Patent Document 3: JP4586374B

### DISCLOSURE OF INVENTION

### Problem to be Solved by the Invention

In the lithium ion secondary battery disclosed in Patent Document 1 (JP2011-513912A), a coating layer that is formed of LiF-based particles is provided on the surface of the negative electrode, and the coating layer functions as a solid electrolyte interface. As a result, the effect of improving long-term cell life time is attained thereby.

However, several problems to be solved are left in the lithium ion secondary battery disclosed in Patent Document 1 in which a coating layer that is formed of LiF-based particles is provided on the surface of the negative electrode.

The first problem is that a coating layer comprising LiF-based particles that functions as a solid electrolyte interface is formed on the surface of the negative electrode, and when a partially damaged portion happens to be caused in the coating layer comprising LiF-based particles, the cycle performance of the secondary battery continue to deteriorate.

The reason why the deterioration in the cycle performance of the secondary battery is progressed in the case when the solid electrolyte interface formed on the electrode electroactive substance surface is partially damaged is the result of the progress of the following process.

Once the surface of the electrode electroactive substance is flawed and thereby, the solid electrolyte interface is damaged, or the material for composing electrode, in which the electrode electroactive substance is comprised, is damaged, the surface of the electrode electroactive substance to which the solid electrolyte interface is not attached is exposed. When repeatedly subjected to the charge and discharge of the secondary battery, the portion where the electrode electroactive substance surface is exposed is easily attacked by the electric field, so that “the intercalation of Li” is further continued. When “the intercalation of Li” reaches an excessive level in the exposed portion, the crystal structure of the surface of the electrode electroactive substance is sequentially fractured, and thus, the “Li intercalation capacity” deteriorates. Therefore, as the charge and discharge cycle of the secondary battery is repeated, the deterioration in the discharge capacity retention rate is accelerated.

Usually, in the case when “LiF”, which is usable for the formation of a solid electrolyte interface, for example, a coating layer that is comprised of LiF-based particles, on the surface of a negative electrode, is not included in the nonaqueous electrolytic solution of a lithium ion secondary battery, the repair of the SEI layer that is comprised of “LiF” is difficult during the charge and discharge cycles of the secondary battery.

In order to form the SEI layer that is comprised of “LiF” on the surface of the negative electrode, first, it is necessary that the precipitation of PF₄ or the like and the production of HF is induced by the reaction of the supporting electrolyte, for example, LiPF₆, and H₂O, which are included in the nonaqueous electrolytic solution. Unless additional HF, or water, which will be consumed in the reconstruction of the SEI layer that is comprised of “LiF”, is present in the secondary battery, the SEI layer that is comprised of “LiF” is not reconstructed at the fractured (damaged) site of the SEI layer that covers the surface of the negative electrode.

Further, the second problem is that the nonaqueous electrolytic solution is filled between the positive electrode and the negative electrode that are stacked via the separator to compose the lithium ion secondary battery, and unless the permeation of the nonaqueous electrolytic solution into gaps in the secondary battery or fine gaps in the negative electrode electroactive substance layer and the positive electrode electroactive substance layer which are used to form the electrodes is sufficient before the time of actual use, a portion where the SEI layer is not formed with sufficient film thickness is present on the surface of the negative electrode electroactive substance or on the surface of the positive electrode electroactive substance. In the case when the portion where the SEI layer is not formed with sufficient film thickness is present on the surface of this negative electrode electroactive substance or on the surface of the positive electrode electroactive substance, as repeatedly subjected to the charge and discharge cycle of the secondary battery, a portion where the SEI layer disappears, and thereby, the surface of the electrode electroactive substance is exposed is generated. The generation of the portion where the SEI layer disappears, and thereby, the surface of the electrode electroactive substance is exposed causes the progress of the deterioration in the capacity retention rate. In the case when the SEI layer cannot be reconstruced on the surface of the electrode electroactive substance during the charge and discharge cycles of the secondary battery, the deterioration in the cycle performance of the secondary battery continues to progress. Unless additional HF, or water, which will be consumed in the reconstruction of the SEI layer on the surface of the electrode electroactive substance is present in the secondary battery, the progress of deterioration in the cycle performance of the secondary battery cannot be prevented.

The present invention provides means for solving the aforementioned problems.

Specifically, it is an object of the present invention to provide

a lithium ion secondary battery, and a positive electrode for the secondary battery, of which the long operating life is attained by preventing the acceleration of deterioration in discharge capacity (capacity retention rate), which is associated with the repetition of the charge and discharge cycle of the secondary battery, even in the case when the surface of the electrode electroactive substance of the lithium ion secondary battery is flawed, and thereby, the solid electrolyte interface is damaged, or when the material that is used to compose the electrode which is comprised of the electrode electroactive substance is fractured, and thereby, the surface of the electroactive substance to which the solid electrolyte interface is not attached is exposed.

In addition, it is another object of the present invention to provide

a lithium ion secondary battery, and a positive electrode for the secondary battery, of which the long operating life is attained by preventing the acceleration of deterioration in discharge capacity (capacity retention rate), which is associated with the repetition of the charge and discharge cycle of the secondary battery, even in the case when

in which even when, as the permeation of the nonaqueous electrolytic solution into fine gaps in the negative electrode electroactive substance layer and the positive electrode electroactive substance layer, which are used to compose the electrodes, is not sufficient, the solid electrolyte interface is not formed with sufficient film thickness on the surface of the electrode electroactive substance when subjected to charge before actual use.

### Means for Solving the Problems

At first, the present inventors have paid attention to such a fact that the solid electrolyte interface layer (SEI layer) that is formed on the surface of the electrode electroactive substance of a lithium ion secondary battery is formed in the process in which the secondary battery is subjected to the steps of “preparatory charge, main charge, and aging” after a nonaqueous electrolytic solution comprising a nonaqueous organic solvent and a supporting electrolyte is injected into the cell.

The electrode is composed of a current collector and an electroactive substance layer, and the electroactive substance layer is formed by binding a particulate electroactive substance to the surface of the current collector using a binding agent. At such a step, water that is adsorbed on the surface of the electroactive substance acts effectively to form an SEI film in which Li₂CO₃ or LiF is used as structure materials on the electroactive substance surface. But, once, for example, the surface of the negative electrode electroactive substance is damaged and the SEI layer is flawed, or a portion to which the SEI layer is not originally attached is exposed, the crystal structure of the negative electrode electroactive substance is easily damaged during Li intercalation, and thereby, deterioration in cell performance such as a negative electrode capacity retention rate is induced, and its progress cannot be stopped.

The present inventors have found that by the means of beforehand comprising “chemically adsorbed water” in the range of 0.03% by mass to 0.15% by mass in the positive electrode, following function is provided in which an SEI layer that is comprised of LiF and the like is formed again through the reaction of the chemically adsorbed water with the electrolytic solution, and thus, the SEI in the damaged portion is repaired, and thereby, the progress of deterioration in cell performance can be prevented.

In addition, the present inventors have found that even in the case when the permeation of the electrolytic solution into the electrodes is not sufficient, and the SEI is not sufficiently attached to the surface of the electroactive substance by subjecting the electrodes to the charge before actual use, by the means of beforehand comprising in the range of 0.03% by mass to 0.15% by mass in the positive electrode, following function is provided in which it is possible to prevent the acceleration of deterioration in discharge capacity when a charge and discharge cycle is repeated, and thereby, the operating life time can be prolonged.

The present invention has been completed based on the above findings.

Specifically, a positive electrode for a secondary battery according to the present invention is

a positive electrode for a secondary battery characterized in that

chemically adsorbed water is comprised in advance at a concentration of 0.03% by mass to 0.15% by mass, preferably 0.06% by mass to 0.10% by mass, in the positive electrode.

In addition, a secondary battery according to the present invention is

a secondary battery comprising a positive electrode in which chemically adsorbed water is comprised at a concentration of 0.06% by mass to 0.3% by mass.

A method for manufacturing a positive electrode for a secondary battery according to the present invention is

a method for manufacturing a positive electrode for a secondary battery, characterized in that

the method comprising steps of:

coating foil comprising aluminum with a pasty slurry comprising a positive electrode electroactive substance that comprises at least Li, Mn, Ni, and O, a binder material, and a conductive auxiliary in a humidity atmosphere at a relative humidity of 10% to a relative humidity of 60%;

drying; and

pressing by application of pressure; and

further comprising a step of

storing the positive electrode in a humidity atmosphere at a relative humidity of 10% to a relative humidity of 60%.

In addition, a method for manufacturing a secondary battery according to the present invention is

a method for manufacturing a secondary battery, characterized in that:

the method comprising:

a step of stacking a positive electrode, in which chemically adsorbed water is comprised at a concentration of 0.03% by mass to 0.15% by mass based on the electrode, on a negative electrode via a separator intervening therebetween;

a step of heat-treating the positive electrode and the negative electrode at a temperature of 50° C. to 150° C. for 4 hours or more before or after the stacking step;

a step of placing the positive electrode and the negative electrode in a package;

a step of injecting an electrolytic solution into the package;

a step of sealing the package;

a plurality of charge steps performed at a temperature of 10° C. to 50° C.; and

a step of leaving the secondary battery at a temperature of 30° C. to 60° C. for 100 hours or more.

### Effect of Invention

By means of the “first effect” that is provided by a positive electrode for a lithium ion secondary battery according to the present invention, a positive electrode for a secondary battery can be provided in which, as “chemically adsorbed water” is comprised at a concentration of 0.03% by mass to 0.15% by mass in the electrode, even when the electrode is flawed, the deterioration in the capacity retention rate that is induced by the repetition of charge and discharge is small.

By means of the “second effect” that is provided by the positive electrode for a lithium ion secondary battery according to the present invention, in the case when a secondary battery is fabricated using the positive electrode for a lithium ion secondary battery, as, in the positive electrode of the fabricated secondary battery, “chemically adsorbed water” is comprised at a concentration of 0.03% by mass to 0.15% by mass in the electrode, a secondary battery is provided in which, even when the permeation of the electrolytic solution into the electrodes is not sufficient, and the solid electrolyte interface is not sufficiently attached by charge before actual use, the acceleration of deterioration in discharge capacity that is induced by the repetition of a charge and discharge cycle is prevented, and thereby, the operating life time is prolonged.

By means of the “third effect” that is provided by the positive electrode for a lithium ion secondary battery according to the present invention, when the electrode is used for the fabrication of the lithium ion secondary battery according to the present invention, as the electrode is heat-treated at a temperature of 50° C. to 150° C. for 4 hours or more in the “heat treatment step” of the electrodes before or after the electrodes are stacked, the amount of “chemically adsorbed water” that is present in the positive electrode can be increased to a concentration of 0.06% by mass to 0.3% by mass that is comprised in the electrode. As a result, as the amount of the “chemically adsorbed water” that reacts with the electrolytic solution is increased, a lithium ion secondary battery can be provided in which, even in the case when the electrode is flawed, or when the permeation of the electrolytic solution into the electrodes is insufficient, and the solid electrolyte interface is not sufficiently formed, the deterioration in the capacity retention rate that is induced by the repetition of charge and discharge is small.

### BRIEF DESCRIPTION OF DRAWINGS

FIG. 1 shows diagrams schematically showing the overall structure of a positive electrode for a secondary battery according to a first embodiment of the present invention;

FIG. 1(a) is a plan view schematically showing the whole structure of the positive electrode for a secondary battery according to the first embodiment of the present invention; and FIG. 1(b) shows a cross-sectional view on the line segment A-A′ in the above plan view and is specifically a cross-sectional view schematically showing the internal structure of the positive electrode for a secondary battery according to the first embodiment of the present invention, that is, positive electrode electroactive substance layers 2 provided on both surfaces of a positive electrode current collector 1, the arrangement of a positive electrode electroactive substance 3, a conductive auxiliary 4, and a binding agent 5, which compose the positive electrode electroactive substance layers 2, and the situation of gap space that is left in the positive electrode electroactive substance layers 2.

FIG. 2 shows diagrams schematically showing the overall structure of one example of a secondary battery according to the first embodiment of the present invention; FIG. 2(a) is a plan view schematically showing the whole structure of the one example of the secondary battery according to the first embodiment of the present invention; FIG. 2(b) shows a cross section on the line segment A-A′ in the above plan view and is specifically a cross-sectional view schematically showing the structure of a secondary battery that is comprised of a layered structure of positive electrodes 14 and negative electrodes 15 stacked with separators 16 intervening between them, which are set up in a laminate package 11, and an electrolytic solution 17 filling the laminate package 11; and FIG. 2(c) is an enlarged view showing the layered structure of the positive electrodes 14 and the negative electrodes 15 that are stacked with the separators 16 intervening between them, as illustrated in the above cross-sectional view, and is specifically a cross-sectional view schematically showing the internal structure of the one example of the secondary battery according to the first embodiment of the present invention, that is, positive electrode electroactive substance layers 2 provided on both surfaces of a positive electrode current collector 1, the arrangement of a positive electrode electroactive substance 3, a conductive auxiliary 4, and a binding agent 5, which are composed of the positive electrode electroactive substance layers 2, the electrolytic solution 17 filling gap space in the positive electrode electroactive substance layers 2, and a “positive electrode surface coat 18” formed on the surface of the positive electrode electroactive substance 3; the separators 16 that prevent a short circuit between the layered positive electrodes 14 and negative electrodes 15; and negative electrode electroactive substance layers 22 provided on both surfaces of a negative electrode current collector 21, the arrangement of a negative electrode electroactive substance 23, the conductive auxiliary 4, and the binding agent 5, which are composed of the negative electrode electroactive substance layers 22, the electrolytic solution 17 filling gap space in the negative electrode electroactive substance layers 22, and a “negative electrode surface coat 19” formed on the surface of the negative electrode electroactive substance 23.

FIG. 3 is a diagram schematically explaining the effect of suppressing the progress of deterioration in the discharge capacity retention rate, in association with the repair of the damaged SEI layer by using the “chemically adsorbed water” of the present invention, and (A) in FIG. 3 shows the charge and discharge cycle performance of the discharge capacity retention rate observed in the case when there is no damage in the SEI layer; (B) in FIG. 3 shows the charge and discharge cycle performance of the discharge capacity retention rate observed in the case when there is damage in the SEI layer, when the repair of the SEI layer is not performed; and (C) in FIG. 3 shows the charge and discharge cycle performance of the discharge capacity retention rate observed in the case when the acceleration of deterioration in the discharge capacity retention rate is suppressed by means of the effect of repairing the damaged SEI layer using the “chemically adsorbed water” when there is damage in the SEI layer.

FIG. 4 is a diagram showing the dependence of the effect of suppressing the progress of deterioration in the discharge capacity retention rate, in association with the repair of the damaged SEI layer using the “chemically adsorbed water” of the present invention, on the concentration of the “chemically adsorbed water” that is comprised in the positive electrode; and in FIG. 4, shows the dependence of the discharge capacity retention rate observed after a charge and discharge cycle is repeated for 500 cycles, in the case when there is no damage in the SEI layer, on the concentration of the “chemically adsorbed water” that is comprised in the positive electrode; and in FIG. 4, ◯ shows the dependence of the discharge capacity retention rate observed after the charge and discharge cycle is repeated for 500 cycles, in the case when there is damage in the SEI layer, on the concentration of the “chemically adsorbed water” that is comprised in the positive electrode.

### DESCRIPTION OF SYMBOLS

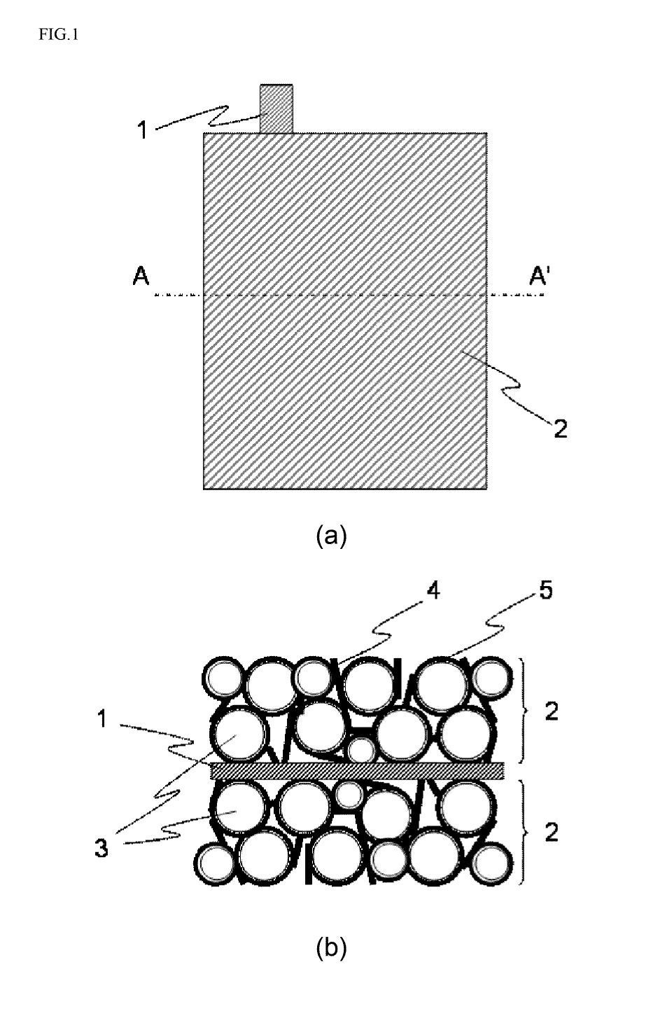

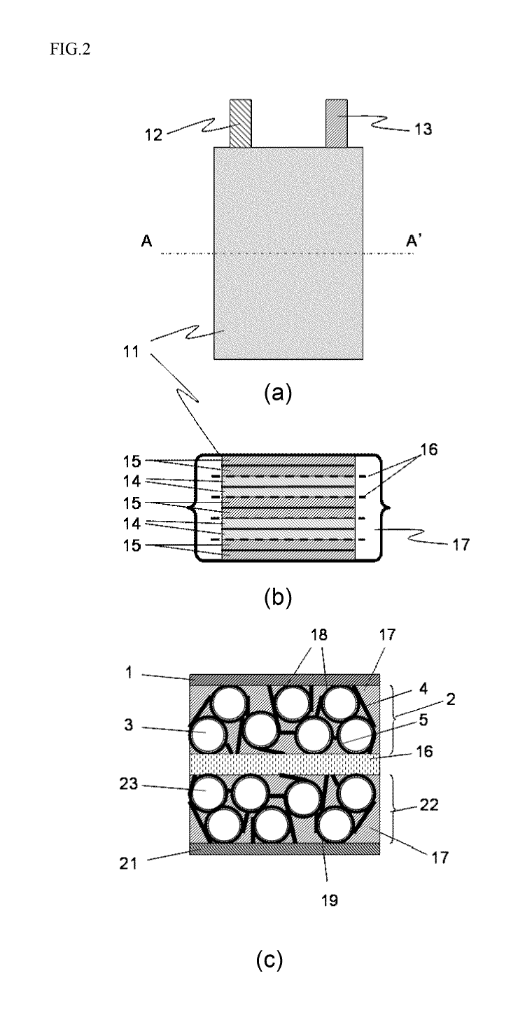

The numeral symbols given in FIG. 1 and FIG. 2 mean the following.

1. positive electrode current collector

2. positive electrode electroactive substance layer

3. positive electrode electroactive substance

4. conductive auxiliary

5. binding agent

8. positive electrode

11. laminate package

12. positive electrode tab

13. negative electrode tab

14. positive electrode

15. negative electrode

16. separator

17. electrolytic solution

18. positive electrode surface coat

19. negative electrode solid electrolyte interface

21. negative electrode current collector

22. negative electrode electroactive substance layer

23. negative electrode electroactive substance

24. package

### BEST MODE FOR CARRYING OUT THE INVENTION

Next, regarding a positive electrode for a lithium ion secondary battery according to the present invention, its typical embodiments will be described in detail with reference to the drawings.

### First Embodiment

FIG. 1(a) is a plan view schematically showing the overall structure of a positive electrode for a lithium ion secondary battery according to a first embodiment of the present invention, and FIG. 1(b) is a cross-sectional view schematically showing a cross section on the line segment A-A′ in the above plan view. However, the cross-sectional structure of the positive electrode for a lithium ion secondary battery according to the first embodiment of the present invention in a cross section at any position other than the line segment A-A′ is substantially the same as that shown for the cross section on the line segment A-A′.

The positive electrode has a structure in which positive electrode electroactive substance layers 2 are provided on both surfaces of a positive electrode current collector 1 comprising aluminum as a main material and having a pair of opposed surfaces. Although not shown, such a structure that has a region where the positive electrode electroactive substance layer 2 is provided on only one surface of the positive electrode current collector 1 may be employed. The film thickness of the positive electrode current collector 1 is selected within 10 μm to 100 μm.

The positive electrode electroactive substance layer 2, for example, comprises a particle-shaped positive electrode electroactive substance 3 and comprises a conductive auxiliary 4 such as a carbon material and a binding agent 5 such as polyvinylidene fluoride (PVdF). As the positive electrode electroactive substance 3, for example, a lithium containing complex oxide such as a compound represented by the chemical formula LiₓMO₂ (x is in the range of 0.5 or more and 1.1 or less, and M is any one of or a plurality of transition metals) is used. Examples of lithium containing complex oxides comprising cobalt or nickel, which are widely used as positive electrode electroactive substances, include LiCoO₂, LiNiO₂, LiₓNi_{y}Co_{1-y}O₂, and LiₓNi_{y}Al_{z}Co_{w}O₂ (x and y differ depending on the charge and discharge condition of the battery and typically, 0.9<x<1.1, 0.7<y<0.98, 0.03<z<0.06, and 0.12<w<0.3). In addition, examples of lithium containing complex oxides comprising manganese include spinel type lithium-manganese complex oxides represented by LiMn₂O₄ and the like. As the positive electrode electroactive substance 3, in addition to the above-described lithium containing complex oxides, any one of metal sulfides and metal oxides containing no lithium such as TiS₂, MoS₂, and V₂O₅ can also be used, or a plurality of them can also be used in combination with the lithium containing complex oxides. As the positive electrode electroactive substance 3, preferably a combination of a spinel type lithium-manganese complex oxide represented by LiMn₂O₄ or the like and a lithium-nickel complex oxide represented by LiₓNi_{y}Al_{z}Co_{w}O₂ is employed. By using said “combination of a spinel type lithium-manganese complex oxide and a lithium-nickel complex oxide,” the generation of “chemically adsorbed water” can be made active through the processes comprising ionization of oxygen atom (O²⁻), in association with Ni valence change, production of OH⁻ and CO₃²⁻ anion species by the reaction of the ionized oxygen (O²⁻) with H₂O and CO₂, and production of LiOH and Li₂CO₃ by reaction with Li. In addition, the film thickness of the positive electrode electroactive substance layer 2 to be formed on one surface of the positive electrode current collector 1 is selected in the range of 30 μm to 100 μm.

There is chemically adsorbed water that is chemically adsorbed on the metal elements comprised in the lithium containing complex oxide, which is used to compose the positive electrode electroactive substance 3. The “chemically adsorbed water” that is chemically adsorbed on the lithium containing complex oxide, which is used to compose the positive electrode electroactive substance 3, is comprised at the water concentration selected in the range of 0.03% by mass to 0.15% by mass based on the total mass W₃ of the positive electrode electroactive substance 3, which is comprised in the positive electrode electroactive substance layers 2 of a positive electrode 14, at a stage before the drying step of the positive electrode 14. The “chemically adsorbed water” that is chemically adsorbed on the lithium containing complex oxide, which is used to form the positive electrode electroactive substance 3, is comprised, for example, in the form of LiOH. The concentration of the “chemically adsorbed water” that is chemically adsorbed on the lithium containing complex oxide, which is used to form the positive electrode electroactive substance 3, can be defined by “water concentration” detected in the range of 200° C. to 300° C. by the Karl Fischer titration method. In addition to said “chemically adsorbed water”, “physically adsorbed water” is present as water adhering to the positive electrode 14 at a stage before the drying step of the positive electrode 14. The concentration of said “physically adsorbed water” can be defined by water concentration detected in the temperature range of 200° C. or less by the Karl Fischer titration method. The “physically adsorbed water” can be evaporated to some extent by subjecting the positive electrode 14 to the drying step therefor. As the “drying conditions” aimed at the removal of the “physically adsorbed water”, which is to be employed in the drying step of the positive electrode 14, a temperature of about 70° C. to 150° C. can be used. In addition, the concentration of the “chemically adsorbed water” can be controlled by the “drying conditions”, which is to be employed in the drying step of the positive electrode 14. As the drying temperature that is employed in the drying step of the positive electrode 14 increases, the “physically adsorbed water” can be evaporated and at the same time can react easily with the metal element that is comprised in the lithium containing complex oxide, which is used to form the positive electrode electroactive substance 2, to form “chemically adsorbed water”. The concentration of the “chemically adsorbed water”, which is comprised in the positive electrode electroactive substance layers 2 of the positive electrode 14 after the completion of the drying step of the positive electrode 14, based on the total mass W₃ of the positive electrode electroactive substance 3 is equal to the concentration of the “chemically adsorbed water” before the drying step of the positive electrode 14 or shows a higher value. For example, in the case when the drying conditions of 120° C. and 10 hours are employed in the drying step of the positive electrode 14, when the concentration of the “chemically adsorbed water” before the drying step of the positive electrode 14 is in the range of 0.03% by mass to 0.15% by mass, the concentration of the “chemically adsorbed water” increases to the range of 0.06% by mass to 0.30% by mass after the drying step of the positive electrode 14. In the “positive electrode for a lithium ion secondary battery” according to the present invention, the concentration of the “chemically adsorbed water” that is comprised in the positive electrode is defined as the value of the concentration of the “chemically adsorbed water” measured before a storage step is carried out after the step of pressing by application of pressure dried slurry coating layers to form positive electrode electroactive substance layers (compression step) is completed.

A plan view of a lithium ion secondary battery that is fabricated using the positive electrode for a secondary battery according to the first embodiment of the present invention is shown in FIG. 2(a). In addition, a cross-sectional view taken along the line segment A-A′ in FIG. 2(a) is shown in FIG. 2(b). Further, among the cross section shown in FIG. 2(b), a cross section of the structure of a portion where the positive electrode electroactive substance layer 2 of the positive electrode 14 and the negative electrode electroactive substance layer 22 of a negative electrode 15 are stacked with a separator 16 intervening between them is illustrated in FIG. 2(c).

As illustrated in FIG. 2(a), the lithium ion secondary battery of a secondary battery according to the first embodiment of the present invention comprises a positive electrode tab 12 comprising aluminum as a main component and a negative electrode tab 13 comprising nickel as a main component, which are extracted from a laminate package 11. As shown in the cross-sectional view of FIG. 2(b), the positive electrodes 14 and the negative electrodes 15 are stacked with the separators 16 intervening between them, and all of the positive electrodes 14, the negative electrodes 15, and the separators 16 with layered arrangement are placed in the laminate package 11 and covered with an electrolytic solution 17 filling the laminate package 11. In addition, the positive electrode current collectors 1 of the positive electrodes 14 and the negative electrode current collectors 21 of the negative electrodes 15 are connected to the above-described positive electrode tab 12 and negative electrode tab 13, respectively, and ends of the positive electrode tab 12 and the negative electrode tab 13 are extracted to the outside of the laminate package 11. Next, an enlarged cross-sectional view illustrating part of the layered structure of the positive electrode current collectors 1 of the positive electrodes 14, the negative electrode current collectors 21 of the negative electrodes 15, and the separators 16 is shown in FIG. 2(c). As shown in FIG. 2(c), a positive electrode surface coat 18 and a negative electrode solid electrolyte interface 19 adhere to the surface of the positive electrode electroactive substance 3 that is comprised in the positive electrode electroactive substance layer 2 of the positive electrode 14 and the surface of the negative electrode electroactive substance 23 that is comprised in the negative electrode electroactive substance layer 22 of the negative electrode 15, respectively. The positive electrode surface coat 18 is comprised of a compound including LiF or Li₂CO₃. The negative electrode solid electrolyte interface 19 also is comprised of a compound including LiF or Li₂CO₃. It is known that the solid electrolyte interface 19 that is formed on the surface of the negative electrode electroactive substance 23 plays an essential role in protecting the crystal structure of the negative electrode electroactive substance 23 from attack during “the intercalation of lithium” in the charge process.

In addition, in each electrode in the lithium ion secondary battery according to the first embodiment of the present invention, the “chemically adsorbed water” is comprised in the positive electrode electroactive substance layers 2 of the positive electrode 14 in the range of 0.06% by mass to 0.30% by mass based on the total mass W₃ of the positive electrode electroactive substance 3, and comprised in the negative electrode electroactive substance layers 22 of the negative electrode 15 in the range of 0.005% by mass to 0.1% by mass based on the total mass W₂₃ of the negative electrode electroactive substance 23 after initial charge.

The negative electrode 15 has, for example, a structure in which the negative electrode electroactive substance layers 22 are provided on both surfaces of the negative electrode current collector 21 having a pair of opposed surfaces, in similar to the positive electrode 14. Although not shown, such a structure that has a region where the negative electrode electroactive substance layer 22 is provided on only one surface of the negative electrode current collector 21 can also be selected. The negative electrode current collector 21 is formed of, for example, metal foil such as copper foil, nickel foil, or stainless foil. The negative electrode electroactive substance layer 22 comprises the negative electrode electroactive substance 23 and a binding agent such as polyvinylidene fluoride, and the particles of the negative electrode electroactive substance 23 are bound to the surfaces of the negative electrode current collector 21 by the binding agent. The negative electrode electroactive substance layer 22 comprises fine gap space between the particles of the negative electrode electroactive substance 23 bound by the binding agent.

As the negative electrode electroactive substance 23, carbonaceous materials and the like that can be doped/dedoped with lithium ions can be used. Examples of the carbonaceous materials that can be used as the negative electrode electroactive substance 23 include graphites such as synthetic graphite and natural graphite, hardly graphitizable carbon, pyrolytic carbons, cokes such as pitch coke, needle coke, and petroleum coke, glassy carbon fibers, organic polymer compound fired bodies obtained by firing phenolic resins, furan resins, and the like at appropriate temperature for carbonization, carbon fibers, activated carbon, and carbon blacks. Any one of these carbonaceous materials is used, or a plurality of these carbonaceous materials are mixed and used. In addition, as the negative electrode electroactive substance 23, for example, graphite, amorphous carbon, Si alloys, Si oxides, Si complex oxides, Sn alloys, Sn oxides, Sn complex oxides, or composites thereof can be employed. When the above carbonaceous materials are comprised in the negative electrode electroactive substance layer 22 with other negative electrode electroactive substances 23, the carbonaceous materials also function as a conductive agent for improving the conductivity of the entire negative electrode electroactive substance layer 22.

The separator 16 isolates the positive electrode 14 from the negative electrode 15 and prevents a current short circuit due to the contact between both electrodes. The separator 16 possesses fine pores that allow lithium ions (Li⁺) in a nonaqueous electrolytic solution to pass. Usually, as the separator 16, a microporous film having a large number of fine pores is utilized. The microporous film used as the separator 16 is a resin film having a large number of micropores in which the average pore diameter of the pores is about 5 μm or less. In addition, as the material of which the microporous resin film is comprised, resin materials that have been used as separators in conventional secondary batteries can be used. Among them, microporous films which are comprised of polypropylene, polyolefins, and the like that are excellent in a short circuit prevention effect and can improve the safety of the lithium ion secondary battery by a shut-down effect can be used.

The electrolytic solution 17 is a nonaqueous electrolytic solution in which a lithium salt, which is used as a supporting electrolyte, is dissolved in a nonaqueous organic solvent. The electrolytic solution 17 is a medium for the migration of lithium ions (Li⁺) during charge and discharge steps. As the nonaqueous organic solvent, a mixed solvent, which is prepared by blending a cyclic carbonate having high dielectric constant and an open chain carbonate having low viscosity, is used. For example, a mixed solvent in which ethylene carbonate (EC) is selected as the cyclic carbonate, and dimethyl carbonate (DEC) is selected as the open chain carbonate, and the mixing ratio (EC:DEC) is selected in the range of 10:90 to 40:60 as a volume ratio is used. For the lithium salt that is used as the supporting electrolyte, lithium hexafluorophosphate (LiPF₆) or lithium tetrafluoroborate (LiBF₄) is used. The lithium salt is dissolved in the nonaqueous organic solvent at a concentration of 0.5 M (mol/l) to 2 M.

In the lithium ion secondary battery according to the first embodiment of the present invention, the “chemically adsorbed water” is comprised in the range of 0.06% by mass to 0.30% by mass in the positive electrode 14 and in the range of 0.005% by mass to 0.1% by mass in the negative electrode 15 after initial charge. Therefore, even if the positive electrode surface coat 18 or the negative electrode solid electrolyte interface 19 is flawed during the handling or operation of the lithium ion secondary battery, for example, LiOH, which composes the “chemically adsorbed water” that is comprised in the positive electrode electroactive substance, reacts with HF in the electrolytic solution, and thereby, the reaction of the following formula (2) is induced. LiF, which is a substance that composes the solid electrolyte interface, produced by the reaction can readhere, and repair the flaw that is induced at the solid electrolyte interface. As a result, it is possible to inhibit the breakage of the crystal structure of the electrode electroactive substance, in association with the excessive “intercalation of Li” that is caused by the flaw at the solid electrolyte interface, and prevent the progress of deterioration in the capacity retention rate of discharge capacity. The progress of deterioration in the capacity retention rate of discharge capacity is prevented, that is, the effect such that the progress of deterioration in the life of the battery can be protected is attained.

LiOH+HF→LiF+H₂O formula (2)

In the “positive electrode for a lithium ion secondary battery” according to the present invention, the concentration of the “chemically adsorbed water” that is comprised in the positive electrode is defined as the value of the concentration of the “chemically adsorbed water” that is measured before the storage step is carried out after the step of pressing by application of pressure dried slurry coating layers to form positive electrode electroactive substance layers (compression step) is completed.

In addition to the “chemically adsorbed water,” the “physically adsorbed water” is also included in the positive electrode. Most of the “physically adsorbed water” evaporates with the dispersion solvent under the “drying conditions” that is employed in the drying step of the positive electrode 14 described above. However, even at a point when the drying step of the positive electrode 14 is completed, in addition to the “chemically adsorbed water,” some amount of the “physically adsorbed water” remains in the positive electrode. For the purpose of distinguishing the “chemically adsorbed water” from this “physically adsorbed water,” in the present invention, the amount of the “chemically adsorbed water” that is comprised in the positive electrode is defined as the amount of water that is to be detected in the range of 200° C. to 300° C. by the Karl Fischer titration method.

Most of the “physically adsorbed water” evaporates before heating up reaches said temperature range of 200° C. to 300° C., at least when heated up to a temperature of less than 200° C. and about 180° C. On the other hand, water molecules (H₂O) that are adsorbed on the surface of the positive electrode electroactive substance 3, in particular on the surface of the lithium containing complex oxide, are converted into the form of LiOH, for example, through the process of Li₂O+H₂O→2LiOH, and thereby, “chemically adsorbed water” are produced. As a result, the amount of water that is detected in the range of 200° C. to 300° C. by the Karl Fischer titration method corresponds to, for example, water molecules (H₂O) that are produced from “chemically adsorbed water” through the process of 2LiOH→Li₂O+H₂O.

In Patent Document 3 (JP4586374B), a measurement sample is placed in a 130° C. heating furnace in which nitrogen gas is flowed, and held for 20 minutes, the flowed nitrogen gas is introduced into the measurement cell of a Karl Fischer aquameter, and the amount of water is measured therein, and therefore, only the concentration of “physically adsorbed water” can be measured. In other words, it is difficult to measure the “chemically adsorbed water” that is used in the present invention by the method for “the measurement of the amount of water” disclosed in Patent Document 3.

Further, as for the repair of the SEI layer, it is considered that the repair of the negative electrode solid electrolyte interface 19 covering the surface of the negative electrode electroactive substance 23 is more effective in preventing the progress of deterioration in the capacity retention rate of discharge capacity. When the amount of the “chemically adsorbed water” that is comprised in the positive electrode 14 is large, the amount of hydroxyl groups (LiOH) that is comprised in the electrolytic solution increases, which promotes the deposition of LiF also on the surface of the negative electrode electroactive substance 23 of the negative electrode 15, and thus, contributing also to the repair of the SEI layer on the surface of the negative electrode electroactive substance 23.

(Description of Manufacturing Methods)

Next, a method for manufacturing a positive electrode for a lithium ion secondary battery according to the first embodiment of the present invention will be described.

First, a positive electrode electroactive substance, a conductive agent, and a binding agent are mixed, for example, in a humidity atmosphere at a relative humidity of 10% to a relative humidity of 60% to prepare a positive electrode mixture. This positive electrode mixture is dispersed in a dispersion solvent such as N-methylpyrrolidone (NMP) to form a positive electrode mixture coating liquid (pasty slurry). Next, the positive electrode current collector 1 is coated with this positive electrode mixture coating liquid to form a positive electrode mixture coating liquid layer. The positive electrode mixture coating liquid layer is dried to provide dried positive electrode mixture coating liquid layer, and then, the dried positive electrode mixture coating liquid layer is compression-molded to form the positive electrode electroactive substance layer 2 to fabricate the positive electrode 14. Next, the fabricated positive electrode 14 is stored in a humidity atmosphere at a relative humidity of 10% to a relative humidity of 60% for 24 hours or more. A drawing showing the process flow of the method for manufacturing a positive electrode for a lithium ion secondary battery according to the first embodiment of the present invention described above is omitted.

The drying step of drying the positive electrode mixture coating liquid layer to provide dried positive electrode mixture coating liquid layer is performed with “drying conditions” in which heating to a temperature selected in the range of 100° C. to 160° C. is performed using a heater.

The process flow of the method for manufacturing a positive electrode for a lithium ion secondary battery according to the first embodiment of the present invention described above comprises the step of storing the positive electrode in a humidity atmosphere at a relative humidity of 10% to a relative humidity of 60% for 24 hours or more after the completion of the compression molding step of compression-molding to form the positive electrode electroactive substance layer 2. Therefore, the “chemically adsorbed water” is comprised in the positive electrode electroactive substance layers 2 of the obtained positive electrode 14 only in the range of 0.03% by mass to 0.15% by mass based on the total mass W₃ of the positive electrode electroactive substance 3.

Therefore, an advantage is attained in which after a lithium ion secondary battery is manufactured using the positive electrode for a lithium ion secondary battery according to the first embodiment of the present invention, the “chemically adsorbed water” that is comprised in the positive electrode for a secondary battery can react with HF present in the electrolytic solution to produce LiF, and it is possible to reconstruct the solid electrolyte interface and self-repair the peeled portion of the solid electrolyte interface.

In addition, in the case when the electrolytic solution has not sufficiently infiltrated into the negative electrode electroactive substance layer 22 and the positive electrode electroactive substance layer 2 during the manufacturing process of the lithium ion secondary battery or just after the manufacture yet, and the electrolytic solution fully infiltrates into the negative electrode electroactive substance layer 22 and the positive electrode electroactive substance layer 2 after the lithium ion secondary battery is in an actually used state, the solid electrolyte interface 19 covering the surface of the negative electrode electroactive substance 23, and the surface coat (solid electrolyte interface) 18 covering the surface of the positive electrode electroactive substance 3 may not be sufficiently formed. Even in this case, the “chemically adsorbed water” covering the surface of the positive electrode electroactive substance 3 reacts with the electrolytic solution 17 to self-form the positive electrode surface coat (solid electrolyte interface) 18, and therefore, the advantage of being able to prevent deterioration in charge and discharge performance (discharge capacity retention rate) when a charge and discharge cycle is repeated is attained.

In addition, in a method for manufacturing a lithium ion secondary battery according to the first embodiment of the present invention, first, the positive electrodes 14 in which “chemically adsorbed water” is comprised at a concentration of 0.03% by mass to 0.15% by mass in the positive electrode, and the negative electrodes 15 are subjected to heat treatment at a temperature selected in the range of 50° C. to 150° C. for 4 hours or more. Next, the positive electrodes 14 and the negative electrodes 15 are stacked via the separators 16 intervening between them so as to face to each other. Next, the positive electrode tab 12 and the negative electrode tab 12 as extraction electrodes are respectively attached to the positive electrode current collectors 1 of the positive electrodes 14 and the negative electrode current collectors 21 of the negative electrodes 15 that are stacked, and the layered electrodes are placed in a package 24 comprising the laminate package 11. After the setting-up, among the four sides of the laminate package 11, of which the package 24 is comprised, three sides, which are other than the side from which the electrolytic solution 17 is injected (opening side), are sealed by welding. The electrolytic solution 17 is injected into the package 24 from the opening side, and finally, the opening side from which the electrolytic solution 17 has been injected is sealed by welding. Next, charge is step-wisely performed by a plurality of steps at a temperature of 10° C. to 50° C., the gas produced in the package 24 is once removed, and at last, aging is carried out to complete the lithium ion secondary battery according to the first embodiment of the present invention. The conditions used for the aging is a treatment of leaving at a temperature selected in the range of 30° C. to 60° C. for 100 hours or more. The step of removing the gas produced in association with the charge may be carried out after the aging treatment is completed.

In the method for manufacturing a lithium ion secondary battery according to the first embodiment of the present invention, the positive electrodes 14 used are subjected to heat treatment at a temperature selected in the range of 50° C. to 150° C. for 4 hours or more. Therefore, the amount of the “chemically adsorbed water” that is comprised in the heat-treated positive electrode 14 can be increased to the range of 0.06% by mass to 0.3% by mass based on the total mass W₃ of the positive electrode electroactive substance 3. Therefore, the amount of the “chemically adsorbed water” that reacts with the electrolytic solution 17 increases, and therefore, such an advantage that the amount of LiF deposited according to the following chemical formulae can be increased is provided.

During the aforementioned charge step, “physically adsorbed water” adhering to the positive electrodes 14, the negative electrodes 15, the separators 16, or the laminate package (aluminum laminate) 11 is dissolved in the electrolytic solution. The reaction of formula (3) is caused by the dissolved “physically adsorbed water” with the lithium salt in the electrolytic solution to produce LiF. In addition, the electrode reaction of formula (4), which is induced by the help of electrons (e⁻) supplied from the electrode, is caused by the lithium salt in the electrolytic solution and the nonaqueous organic solvent (cyclic carbonate) to produce Li₂CO₃. Using the produced LiF and Li₂CO₃, a stable SEI layer is formed on the surface of the electrode electroactive substance in contact with the electrolytic solution.

LiPF₆+H₂O→LiF↓+2HF+POF₃ formula (3)

EC+2e⁻+2Li⁺→Li₂CO₃↓+CH₂CH₂↑ formula (4)

During the operation of the charge and discharge of the lithium ion secondary battery, in the surface portion of the electrode electroactive substance in direct contact with the electrolytic solution, that is, a portion to which the SEI layer is not attached, or a portion where the SEI layer is damaged, the reaction of formula (2) is caused by HF that is produced by the reaction of formula (3) with LiOH that is in contact with the electrolytic solution to selectively deposit LiF on the surface of the electrode electroactive substance in the portion.

LiOH+HF→LiF↓+H₂O formula (2)

Therefore, a portion which is not covered with the SEI layer, or a fissure in the SEI layer (the damaged portion of the SEI layer) can be effectively repaired with a deposit comprising LiF. As a result, it is possible to suppress accelerated deterioration in the discharge capacity retention rate, in association with charge and discharge cycles, which is caused by damage to the SEI layer, and thereby, the effect of extending the life time of the battery is provided. The reaction of formula (3) is caused similarly on both the positive electrode and the negative electrode, and the reaction of formula (4) is induced by electrons (e⁻) that are supplied from the electrode on the negative electrode during charge and on the positive electrode during discharge. On the other hand, as a relatively large amount of LiOH is present on the surface of the positive electrode electroactive substance 3, the reaction of formula (2) has more effect on the repair of “damage to the SEI layer” on the surface of the positive electrode electroactive substance 3. On the other hand, also on the negative electrode, in the case when Li remaining on the surface of the negative electrode electroactive substance 23 is converted to LiOH during discharge, the deposition of LiF is progressed according to the reaction of formula (2). By means of said deposition of LiF, a surface coat layer comprising LiF is formed so as to repair a portion to which the SEI layer is not originally attached, or a fissure in the SEI layer (the damaged portion of the SEI layer), of the surface of the negative electrode electroactive substance 23. In addition, Li that has migrated from the positive electrode to the negative electrode by diffusion or drift is also a factor that forms LiOH on the surface of the negative electrode electroactive substance 23. In other words, when LiOH that has been formed on the surface of the negative electrode electroactive substance 23 for some reason comes into contact with the electrolytic solution, the reaction of formula (2) can be caused by said LiOH with use of HF that is contained in the electrolytic solution, to selectively deposit LiF at said specific portion on the surface of the negative electrode electroactive substance 23.

(First Exemplary Mode)

The fabrication conditions will be more specifically described by taking as an example a “First Exemplary Mode” in which a lithium ion secondary battery is fabricated based on the method for manufacturing a lithium ion secondary battery according to the first embodiment of the present invention.

In the positive electrode 14 that is used, 20 μm thick aluminum foil is used as the positive electrode current collector 1, and a mixture obtained by mixing Li(LiₓMn₂₋ₓ)O₄ (x is in the range of 0.1<x<0.6), which is a spinel type lithium-manganese complex oxide, and LiNi_{0.8}Co_{0.15}Al_{0.05}O₂, which is a lithium-nickel complex oxide, at a mass ratio of 80:20 is used as the positive electrode electroactive substance 3. The concentration of “chemically adsorbed water” that is comprised in the positive electrode 14 was 1200 ppm based on the total mass W₃ of the positive electrode electroactive substance 3. In the process for fabrication of the positive electrode, the “drying conditions” used in “the step of drying the positive electrode” are 120° C. and 8 hours.

In addition, in the negative electrode 15, 10 μm thick copper foil is used as the negative electrode current collector 21, and graphite is used as the negative electrode electroactive substance 23. When the negative electrode electroactive substance layer is formed, the “drying conditions” used in “the step of drying the negative electrode” are 90° C. and 8 hours.

By using LiPF₆ as a supporting electrolyte, and a carbonate compound having an unsaturated bond, specifically ethylene carbonate (EC), as a nonaqueous organic solvent, the electrolytic solution is prepared in the form of a solution having a LiPF₆ concentration of 1 M.

Next, the positive electrodes 14 and the negative electrodes 15 were stacked via the separators 16 that are comprised of polyethylene to fabricate a laminate-packaged lithium ion secondary battery. The positive electrodes 14 were used for the fabrication of the secondary battery after being stored under the conditions of a temperature of 23° C. and a relative humidity of 40% for about 1 week.

The concentration of the “chemically adsorbed water” that is comprised in the positive electrode 14 after initial charge is about 2300 ppm based on the total mass W₃ of the positive electrode electroactive substance 3, which is an amount sufficient to achieve the repair of the SEI layer. The concentration of the “chemically adsorbed water” that is comprised in the positive electrode 14 reaches about 2300 ppm, which is an amount of the “chemically adsorbed water” sufficient for the repair of the SEI layer even if a portion not sufficiently coated with the SEI layer, or a portion where the SEI layer is cracked (the damaged portion of the SEI layer) is present. Therefore, an effect is attained that accelerated deterioration in the discharge capacity retention rate, in association with charge and discharge during the operation of the secondary battery, which is caused by the defected portion of the SEI layer or the damaged portion of the SEI layer, can be suppressed by the repair of the SEI layer.

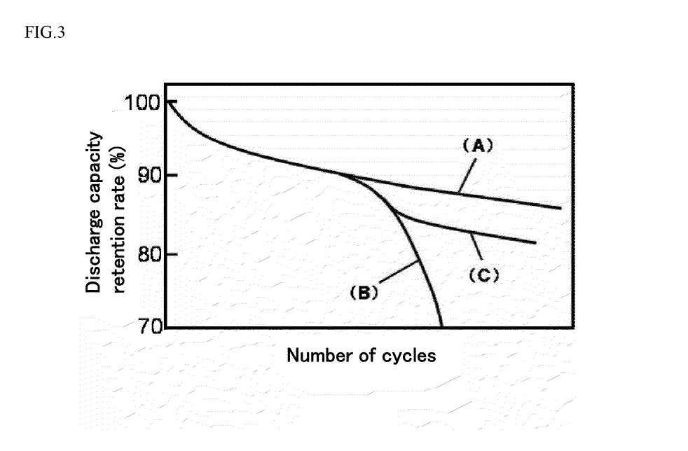

Next, the effects of the present invention, particularly the effect of suppressing deterioration in the discharge capacity retention rate in the secondary battery by the repair of the damaged SEI layer by means of the “chemically adsorbed water”, will be explained with reference to FIG. 3.

FIG. 3 schematically illustrates the cycle dependence of the discharge capacity retention rate of the lithium ion secondary battery, which is obserbed when a cycle test is performed at 25° C. Usually, in the case when there is no flaw in the SEI layer, as the lithium ion secondary battery undergoes charge and discharge cycles, the discharge capacity retention rate decreases gradually, for example, as shown by the curve of (A). In the case when the SEI layer is flawed, when the repair of the SEI layer is not performed, the discharge capacity retention rate decreases (deteriorates) at an accelerated rate, if the number of charge and discharge cycles exceeds a certain threshold, for example, as shown by the curve of (B). Once accelerated deterioration in the discharge capacity retention rate is initiated, the rate of deterioration cannot be suppressed.

In the lithium ion secondary battery according to the first embodiment of the present invention, in the case when the SEI layer is flawed, rapid decrease (deteriorate) in the discharge capacity retention rate is initiated, if the number of charge and discharge cycles exceeds a certain threshold, for example, as shown by the curve of (C). After that, the decrease rate of the discharge capacity retention rate is reduced to the same level as the decrease rate of the discharge capacity retention rate that is observed in the case when there is no flaw in the SEI layer shown by the curve of (A). In other words, an accelerated increase in the deterioration rate is suppressed. It is concluded that the effect that, for example, as shown by the curve of (C), the decrease rate of the discharge capacity retention rate is reduced to the same level as the decrease rate of the discharge capacity retention rate that is observed in the case when there is no flaw in the SEI layer shown by the curve of (A) is due to the fact that the repair of the SEI layer is performed on the damaged portion of the SEI layer. In other words, it is demonstrated that as a result of the effect (action) of the repair of the damaged SEI layer by means of the “chemically adsorbed water,” an accelerated decrease (deterioration) in the discharge capacity retention rate, which is induced by damage to the SEI layer, can be suppressed.

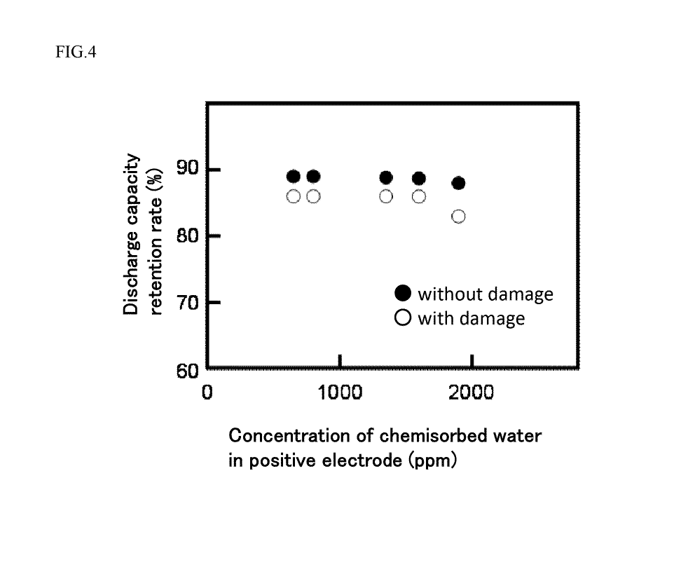

Next, FIG. 4 shows the results of examining, in the lithium ion secondary battery according to the first embodiment of the present invention, the dependence of the cycle performance of the secondary battery on the concentration of the “chemically adsorbed water” that is comprised in the positive electrode used for the fabrication of the secondary battery. Specifically, FIG. 4 shows the results of examining the dependence of the discharge capacity retention rate at a point when a charge and discharge cycle is repeated for 500 cycles in the case when a cycle test is performed at 25° C. on the concentration of the “chemically adsorbed water” that is comprised in the positive electrode used for fabrication.

In FIG. 4, shows the dependence of the discharge capacity retention rate observed after the charge and discharge cycle is repeated for 500 cycles on the concentration of the “chemically adsorbed water” that is comprised in the positive electrode in the case when there is no damage in the SEI layer; and

In FIG. 4, ◯ shows the dependence of the discharge capacity retention rate observed after the charge and discharge cycle is repeated for 500 cycles on the concentration of the “chemically adsorbed water” that is comprised in the positive electrode in the case when there is damage in the SEI layer.

For a plurality of lithium ion secondary batteries that are fabricated using five types of positive electrodes in which the concentration of the “chemically adsorbed water” that is comprised in the positive electrode is selected in the range of 600 ppm (0.06% by mass) to 1800 ppm (0.18% by mass), a cycle test is carried out, and those showing cycle performance as shown by (A) in FIG. 3 are taken as “without a damage”, and those showing cycle performance as shown by (C) in FIG. 3 are taken as “with a damage”, and discharge capacity retention rates that are observed for the secondary batteries “without a damage” after the charge and discharge cycle is repeated for 500 cycles, and discharge capacity retention rates ◯ that are observed for the secondary batteries “with a damage” after the charge and discharge cycle is repeated for 500 cycles are summarized in FIG. 4.

For the purpose of adjusting the concentration of the “chemically adsorbed water” that is comprised in the positive electrode, the target concentration of the “chemically adsorbed water” is achieved by appropriately selecting “the duration of leaving in the air” in the storage step of “storing the fabricated positive electrode 14 in a humidity atmosphere at a relative humidity of 10% to a relative humidity of 60% for 24 hours or more”. However, for the three types of positive electrodes wherein the concentration of the “chemically adsorbed water” that is comprised in the positive electrode exceeds 0.12% by mass, the target concentration of the “chemically adsorbed water” is achieved by appropriately selecting the “duration of leaving” when leaving them in a humidity atmosphere at a relative humidity of 70%.

Among the lithium ion secondary batteries that are fabricated using “positive electrodes” wherein the concentration of the “chemically adsorbed water” that is comprised in the positive electrode is set to a level exceeding 0.15% by mass by storing in a humidity atmosphere at a relative humidity of 70%, when the secondary batteries “with a damage” showing cycle performance as shown by (C) in FIG. 3 are compared with the secondary batteries “without a damage” showing cycle performance as shown by (A) in FIG. 3, there is found out a difference of about 5% in the discharge capacity retention rate between them.

On the other hand, among the lithium ion secondary batteries that are fabricated using “positive electrodes” wherein the concentration of the “chemically adsorbed water” that is comprised in the positive electrode is set in the range of 0.15% by mass or less by appropriately selecting the storing conditions to adjust the concentration of the “chemically adsorbed water”, when the secondary batteries “with a damage” showing cycle performance as shown by (C) in FIG. 3 are compared with the secondary batteries “without a damage” showing cycle performance as shown by (A) in FIG. 3, there is found out only a difference of about 2% in the discharge capacity retention rate between them.

Even in the case of the secondary batteries “without a damage” showing cycle performance as shown by (A) in FIG. 3, when the concentration of the “chemically adsorbed water” that is comprised in the positive electrode exceeds 0.15% by mass, the decrease in the discharge capacity retention rate is significant. On the other hand, the lower limit of the concentration of the “chemically adsorbed water” that is to be comprised in the positive electrode is defined as the lowest concentration of the “chemically adsorbed water” at which LiF can be produced, and is 0.03% by mass.

### Second Embodiment

The positive electrode for a lithium ion secondary battery according to the first embodiment of the present invention uses a “positive electrode electroactive substance comprising a lithium containing complex oxide” as the positive electrode electroactive substance 2. The positive electrode for a lithium ion secondary battery according to the second embodiment of the present invention uses an iron phosphate type electroactive substance having an olivine type crystal structure such as LiFePO₄, as the positive electrode electroactive substance 3, instead of the “positive electrode electroactive substance comprising a lithium containing complex oxide”.

As a stable crystal structure is formed by means of phosphate (PO₄), the iron phosphate type positive electrode electroactive substance has high thermal stability during charge. Therefore, a lithium ion secondary battery in which the fluctuations in performance are small even if it is used at high temperature is provided. In addition, by controlling the concentration of the “chemically adsorbed water” that is comprised in the positive electrode within an appropriate range, a portion which is not covered with the SEI layer or a fissure in the SEI layer (the damaged site of the SEI layer) on the surface of the positive electrode electroactive substance 3 can be effectively repaired with a deposit comprising LiF by the use of the “chemically adsorbed water”. Therefore, an effect is attained that accelerated deterioration in the discharge capacity retention rate in association with charge and discharge during the operation of the secondary battery, which is caused by the defected portion of the SEI layer or the damaged portion of the SEI layer, can be suppressed by the repair of the SEI layer. As a result, an advantage is provided that an effect that the life time of the battery is extended is also simultaneously attained.

### Third Embodiment

In the method for manufacturing a positive electrode for a lithium ion secondary battery according to the first embodiment of the present invention, “drying conditions” in which heating to a temperature selected in the range of 100° C. to 160° C. is carried out under unreduced pressure using heater heating is employed in “the drying step of the positive electrode”.

In a method for manufacturing a positive electrode for a lithium ion secondary battery according to a third embodiment of the present invention, “drying conditions” in which heating to a temperature selected in the range of 80° C. to 130° C. is carried out under vacuum of 0.1 Pa to 100 Pa is employed in “the drying step of the positive electrode.”

When the “drying conditions” in which heating to a temperature selected in the range of 80° C. to 130° C. is carried out under a vacuum of 0.1 Pa to 100 Pa is employed in “the drying step of the positive electrode,” the amount of “physically adsorbed water” evaporated increases. As a result, the amount of the “physically adsorbed water” remaining in the fabricated positive electrode for a lithium ion secondary battery is relatively reduced. In addition, the ratio in which the water molecules (H₂O) of the “physically adsorbed water” adsorbed on the surface of the positive electrode electroactive substance 3, e.g. the surface of the lithium containing complex oxide, are converted into the form of LiOH, for example, through the process of Li₂O+H₂O→2LiOH, to produce “chemically adsorbed water” during “the drying step of the positive electrode” is reduced. In other words, the amount of increase in the concentration of the “chemically adsorbed water” that is comprised in the positive electrode, which proceeds during “the drying step of the positive electrode”, decreases relatively.

The fabricated positive electrode 14 is stored in a humidity atmosphere at a relative humidity of 10% to a relative humidity of 60% for 24 hours or more. By the storage step in the humidity atmosphere, the amount of the “physically adsorbed water” that is contained in the positive electrode 14 is adjusted (made uniform) to an amount balanced with the relative humidity in the humidity atmosphere.

Therefore, an advantage is provided that, when a lithium ion secondary battery is constructed using the positive electrode for a lithium ion secondary battery, which is fabricated by the method for manufacturing a positive electrode for a lithium ion secondary battery according to the third embodiment of the present invention, it is possible to make uniform the film thickness of the SEI layer formed during initial charge, formed using “physically adsorbed water” having uniform concentration contained in the positive electrode 14 after the storage step.

On the other hand, in the positive electrode for a lithium ion secondary battery that is fabricated by the method for manufacturing a positive electrode for a lithium ion secondary battery according to the third embodiment of the present invention, the amount of LiOH, which is comprised of the “chemically adsorbed water”, decreases relatively, but an SEI layer having uniform film thickness and being stable is formed during initial charge. Therefore, the ability to repair the SEI layer is relatively reduced in proportion to the relative decrease in the “chemically adsorbed water”, but, as “damage to the SEI layer” to be repaired also decreases relatively, an effect is sufficiently attained that accelerated deterioration in the discharge capacity retention rate, in association with charge and discharge during the operation of the secondary battery, which is caused by the defected portion of the SEI layer or the damaged portion of the SEI layer, can be suppressed by the repair of the SEI layer. Particularly, as the incidence of the defected portion of the SEI layer is suppressed, an advantage is provided that sufficiently stable cycle performance can be achieved.

In addition, the positive electrodes for lithium ion secondary batteries according to the first embodiment to the third embodiment of the present invention are arranged in the structure on the premise that they are used in laminate type lithium ion secondary batteries. Of course, the positive electrode for a lithium ion secondary battery according to the present invention can also be arranged in the suitable structure for use in a coin type lithium ion secondary battery. In the case of the positive electrode for a secondary battery used in a coin type lithium ion secondary battery, the possibility that the negative electrode electroactive substance layer or the positive electrode electroactive substance layer is flawed during the secondary battery fabrication step is significantly low. But, the effect such that sufficiently stable cycle performance can be achieved, which is provided by the present invention, is essentially identical even in such a case.

The invention of this application has been described above with reference to the embodiments (and Examples), but the invention of this application is not limited to the above embodiments (and Examples). Various changes that can be understood by those skilled in the art can be made in the configuration and details of the invention of this application within the scope of the invention of this application.

This application claims priority to Japanese Patent Application No. 2012-110722 filed May 14, 2012, the entire disclosure of which is incorporated herein.

### INDUSTRIAL APPLICABILITY

The positive electrode for a lithium ion secondary battery and the lithium ion secondary battery according to the present invention can be preferably used as electrodes for lithium ion secondary batteries and as lithium ion secondary batteries, which are used in electric vehicles, hybrid electric vehicles, electric bicycles, electric motorcycles, large electricity storage systems, home electricity storage systems, electricity storage systems connected to solar panels, and smart grids effectively utilizing electric power.

The positive electrode for a lithium ion secondary battery and the lithium ion secondary battery, the methods for manufacturing the same, and the typical embodiments thereof according to the present invention can also be described in forms described in the following (Note 1) to (Note 20).

(Note 1)

A positive electrode for a secondary battery used for fabrication of a lithium ion secondary battery, characterized in that:

the positive electrode comprising:

a positive electrode current collector; and

a positive electrode electroactive substance layer that is comprised of a positive electrode electroactive substance, a conductive auxiliary, and a binder, which is coated at least on one surface of the positive electrode current collector, wherein

chemically adsorbed water is comprised at a concentration of 0.03% by mass to 0.15% by mass based on a total mass W₃ of the positive electrode electroactive substance, in the positive electrode, and

the chemically adsorbed water is water content that is to be detected in a range of 200° C. to 300° C. by Karl Fischer titration method.

(Note 2)

The positive electrode for a secondary battery according to (Note 1), wherein

the positive electrode electroactive substance comprises a lithium containing complex oxide.

(Note 3)

The positive electrode for a secondary battery according to (Note 1), wherein

the positive electrode electroactive substance is an iron phosphate type positive electrode electroactive substance.

(Note 4)

The positive electrode for a secondary battery according to (Note 1), wherein

the positive electrode electroactive substance comprises a spinel type lithium-manganese complex oxide and a lithium-nickel complex oxide.

(Note 5)

The positive electrode for a secondary battery according to any of (Note 1) to (Note 4), wherein

the positive electrode current collector comprises foil comprising aluminum as a main raw material.

(Note 6)

The positive electrode for a secondary battery according to any of (Note 1) to (Note 5), wherein

the conductive auxiliary comprises carbon.

(Note 7)

The positive electrode for a secondary battery according to any of (Note 1) to (Note 6), wherein

the binder comprises fluorine and carbon.

(Note 8)

A lithium ion secondary battery comprising a positive electrode, a negative electrode, a separator isolating the positive electrode from the negative electrode, and an electrolytic solution, characterized in that:

the positive electrode comprises

a positive electrode current collector, and

a positive electrode electroactive substance layer, which comprises a positive electrode electroactive substance, a conductive auxiliary, and a binder, coating at least one surface of the positive electrode current collector, and

chemically adsorbed water is comprised at a concentration of 0.06% by mass to 0.3% by mass based on a total mass W₃ of the positive electrode electroactive substance, in the positive electrode, wherein

the chemically adsorbed water is water content that is to be detected in a range of 200° C. to 300° C. by Karl Fischer titration method.

(Note 9)

The secondary battery according to (Note 8), wherein

the positive electrode electroactive substance comprises a lithium containing complex oxide.

(Note 10)

The secondary battery according to (Note 8), wherein

the positive electrode electroactive substance is an iron phosphate type positive electrode electroactive substance.

(Note 11)

The secondary battery according to (Note 8), wherein

the positive electrode electroactive substance comprises a spinel type lithium-manganese complex oxide and a lithium-nickel complex oxide.

(Note 12)

The secondary battery according to any of (Note 8) to (Note 11), wherein

the positive electrode current collector comprises foil comprising aluminum as a main raw material.

(Note 13)

The secondary battery according to any of (Note 8) to (Note 12), wherein

the conductive auxiliary comprises carbon.

(Note 14)

The secondary battery according to any of (Note 8) to (Note 13), wherein

the binder comprises fluorine and carbon.

(Note 15)

The secondary battery according to any of (Note 8) to (Note 14), wherein

the lithium secondary battery comprising:

the positive electrode, the negative electrode, the separator isolating the positive electrode from the negative electrode, and the electrolytic solution, which are set in an aluminum laminate, and

metallic tabs which are lead-out from the positive electrode and the negative electrode connecting to an outside of the aluminum laminate.

(Note 16)

The secondary battery according to any of (Note 8) to (Note 15), wherein

the electrolytic solution is a nonaqueous electrolytic solution using a nonaqueous organic solvent as a solvent, and

uses at least one of LiPF₆, LiBF₄, and LiAsF₄ as a main component of a supporting electrolyte.

(Note 17)

The secondary battery according to (Note 16), wherein

the electrolytic solution comprises at least one of a carbonate compound having an unsaturated bond, a sultone compound, and a disulfonate as the nonaqueous organic solvent.

(Note 17)

The secondary battery according to any of (Note 8) to (Note 16), wherein

the negative electrode comprises

copper foil as a negative electrode current collector, and

at least one surface of the copper foil is coated with a negative electrode electroactive substance that is composed of carbon material.

(Note 18)

The secondary battery according to any of (Note 8) to (Note 17), wherein

the separator comprises

a microporous film composed of polypropylene or polyolefin, which has micropores with an average pore diameter of about 5 μm or less.

(Note 18)

The secondary battery according to (Note 15), wherein

among the metallic tabs,

the metallic tab connected to the positive electrode is made of a metal comprising aluminum, and

the metal tab connected to the negative electrode is made of a metal comprising nickel.

(Note 19)

A method for manufacturing a positive electrode for a secondary battery that is used for fabrication of a lithium ion secondary battery, characterized in that:

the positive electrode for a secondary battery is composed of:

foil comprising aluminum, that is used as a positive electrode current collector, and

a positive electrode electroactive substance layer comprising a positive electrode electroactive substance, a conductive auxiliary, and a binder, that is formed on at least one surface of the positive electrode current collector, wherein

a spinel type lithium-manganese complex oxide and a lithium-nickel complex oxide is comprised as the positive electrode electroactive substance, and

the method comprising steps of:

forming a coating layer of a pasty slurry by coating a surface of the positive electrode current collector with the pasty slurry which is prepared by dispersing the positive electrode electroactive substance, the conductive auxiliary, and the binder in a dispersion solvent;

converting the coating layer to a dried coating layer by subjecting the coating layer to drying treatment for evaporating the dispersion solvent included in the coating layer of the pasty slurry;

pressing the dried coating layer by application of pressure to form the positive electrode electroactive substance layer; and

storing the positive electrode for a secondary battery comprising the positive electrode electroactive substance layer and the positive electrode current collector in a humidity atmosphere at a relative humidity of 10% to a relative humidity of 70%.

(Note 20)

A method for manufacturing a package-sealed lithium ion secondary battery, characterized in that:

the package-sealed lithium ion secondary battery comprising

a positive electrode, a negative electrode, a separator isolating the positive electrode from the negative electrode, and an electrolytic solution, wherein

the positive electrode being stacked on the negative electrode via the separator intervening between them, and being set in a package,

the electrolytic solution being injected into the package, and then, the package being sealed; and

the method comprising:

a stacking step of stacking the positive electrode on the negative electrode via the separator intervening between them;

a setting step of setting the positive electrode and the negative electrode, which are stacked via the separator, in the package;

an electrolytic solution injection step of injecting the electrolytic solution into the package;

an initial charge step of subjecting the secondary battery to step-wise charging a plurality of times at a temperature of 10° C. to 50° C. after the electrolytic solution injection step;

an aging step of subjecting the secondary battery to aging treatment by leaving it at a temperature of 30° C. to 60° C. for 100 hours or more after the initial charge step; and

a package sealing step of sealing the package after the aging step;

wherein

a heat treatment step of heat-treating the positive electrode and the negative electrode at a temperature of 50° C. to 150° C. for 4 hours or more is provided prior to the stacking step,

the positive electrode that is used for fabrication is composed of:

a positive electrode current collector, and

a positive electrode electroactive substance layer, that is comprised of a positive electrode electroactive substance, a conductive auxiliary, and a binder coating at least one surface of the positive electrode current collector;

chemically adsorbed water is comprised at a concentration of 0.03% by mass to 0.15% by mass based on a total mass W₃ of the positive electrode electroactive substance, in the positive electrode, and

the chemically adsorbed water is water content that is to be detected in a range of 200° C. to 300° C. by Karl Fischer titration method.

1. A positive electrode for a secondary battery, which is used to manufacture a lithium ion secondary battery, characterized in that:
the positive electrode is composed of:
a positive electrode current collector; and
a positive electrode electroactive substance layer that is comprised of a positive electrode electroactive substance, a conductive auxiliary, and a binder, which is coated at least on one surface of the positive electrode current collector,
wherein
the positive electrode electroactive substance is
a lithium containing complex oxide comprising cobalt or nickel, or
a combination of a spinel type lithium-manganese complex oxide represented by LiMn₂O₄ or the like and a lithium-nickel complex oxide represented by LiₓNi_{y}Al_{z}Co_{w}O₂;
wherein the content ratio of the spinel type lithium-manganese complex oxide to the lithium-nickel complex oxide, which are comprised in the combination; (the mass of the spinel type lithium-manganese complex oxide/the mass of the lithium-nickel complex oxide) is selected within the range of no larger than 80/20;
the positive electrode is produced by forming the positive electrode electroactive substance layer through following step 1 to step 5:
(Step 1)
a step of preparing a positive electrode mixture by mixing the positive electrode electroactive substance, the conductive agent, and the binding agent in a humidity atmosphere at a relative humidity of 10% to a relative humidity of 70%;
(Step 2)
a step of preparing a positive electrode mixture coating liquid (pasty slurry) by dispersing the positive electrode mixture in an organic solvent that is used as a dispersion solvent;
(Step 3)
a step of forming a positive electrode mixture coating liquid layer by coating the positive electrode mixture coating liquid on the positive electrode current collector;
(Step 4)
a step of drying the positive electrode mixture coating liquid layer to provide a dried positive electrode mixture coating liquid layer; and
(Step 5)
a step of compression-molding the dried positive electrode mixture coating liquid layer to form the positive electrode electroactive substance layer;
wherein the condition used for drying the positive electrode mixture coating liquid layer in the step 4 is selected either of following two drying condition:
“drying condition” in which heating to a temperature selected in the range of 100° C. to 160° C. is performed under unreduced pressure, or
“drying condition” in which heating to a temperature selected in the range of 80° C. to 130° C. is performed in a vacuum of 0.1 Pa to 100 Pa;
a concentration of chemically adsorbed water based on a total mass W₃ of the positive electrode electroactive substance, which is comprised in the positive electrode electroactive substance layer of the positive electrode that is subjected to the treatment of drying under the selected condition for drying the positive electrode mixture coating liquid layer in the step 4, is selected within the range of 0.06% by mass to 0.3% by mass, wherein
the chemically adsorbed water is water content that is to be detected in a range of 200° C. to 300° C. by Karl Fischer titration method.

2. The positive electrode for a secondary battery according to claim 1, wherein
the concentration of the chemically adsorbed water that is comprised in the positive electrode mixture coating liquid layer comprising the positive electrode electroactive substance, the conductive auxiliary and the binder, which is coated at least on one surface of the positive electrode current collector, is selected in the range of 0.03% by mass to 0.15% by mass based on the total mass W₃ of the positive electrode electroactive substance, which is comprised in the positive electrode electroactive substance layer of the positive electrode.

3. The positive electrode for a secondary battery according to claim 1, wherein
the positive electrode current collector comprises foil that comprises aluminum as a main raw material therefor.

4. The positive electrode for a secondary battery according to claim 1, wherein
the positive electrode electroactive substance is
a combination of a spinel type lithium-manganese complex oxide represented by LiMn₂O₄ or the like and a lithium-nickel complex oxide represented by LiₓNi_{y}Al_{z}Co_{w}O₂;
wherein the content ratio of the spinel type lithium-manganese complex oxide to the lithium-nickel complex oxide, which are comprised in the combination; (the mass of the spinel type lithium-manganese complex oxide/the mass of the lithium-nickel complex oxide) is selected within the range of no larger than 80/20.

5. The positive electrode for a secondary battery according to claim 1, wherein
the conductive auxiliary comprises carbon.

6. The positive electrode for a secondary battery according to claim 1, wherein
the binder comprises fluorine and carbon.

7. A method for manufacturing a positive electrode for a secondary battery, characterized in that:
the method comprising steps of:
coating foil comprising aluminum with a pasty slurry comprising a positive electrode electroactive substance, a binder material, and a conductive auxiliary, which are dispersed in an organic solvent that is used as a dispersion solvent, in a humidity atmosphere at a relative humidity of 10% to a relative humidity of 60%;
drying; and
pressing by application of pressure; and
further comprising a step of storing the positive electrode in a humidity atmosphere at a relative humidity of 10% to a relative humidity of 60% for 24 hours or more,
chemically adsorbed water is comprised in a resulted positive electrode electroactive substance layer of the positive electrode positive, after the storing step of, within the range of 0.03% by mass to 0.15% by mass based on the total mass W₃ of the positive electrode electroactive substance, wherein
the chemically adsorbed water is water content that is to be detected in a range of 200° C. to 300° C. by Karl Fischer titration method.

8. A secondary battery, characterized in that:
the secondary battery comprising
a positive electrode for a secondary battery, wherein chemically adsorbed water is comprised in a positive electrode electroactive substance layer of the positive electrode at a concentration of 0.06% by mass to 0.3% by mass based on a total mass W₃ of a positive electrode electroactive substance, wherein
the chemically adsorbed water is water content that is to be detected in a range of 200° C. to 300° C. by Karl Fischer titration method, and
the concentration of the chemically adsorbed water is a concentration that is to be measured after initial charge of the secondary battery.

9. The secondary battery according to claim 8, wherein
the secondary battery comprising:
the positive electrode, a negative electrode, a separator isolating the positive electrode from the negative electrode, and an electrolytic solution, which are set in an aluminum laminate; and
metallic tabs which are lead-out from the positive electrode and the negative electrode connecting to an outside of the aluminum laminate.

10. A method for manufacturing a secondary battery, characterized in that:
the method comprising:
a step of stacking a positive electrode, in which chemically adsorbed water is comprised in a positive electrode electroactive substance layer of the positive electrode at a concentration of 0.03% by mass to 0.15% by mass based on a total mass W₃ of a positive electrode electroactive substance, on a negative electrode via a separator intervening therebetween;
a step of heat-treating the positive electrode and the negative electrode at a temperature of 50° C. to 150° C. for 4 hours or more before or after the stacking step;
a step of placing the positive electrode and the negative electrode in a package;
a step of injecting an electrolytic solution into the package;
a step of sealing the package;
a plurality of charge steps performed at a temperature of 10° C. to 50° C.; and
a step of leaving the secondary battery at a temperature of 30° C. to 60° C. for 100 hours or more, wherein
the chemically adsorbed water is water content that is to be detected in a range of 200° C. to 300° C. by Karl Fischer titration method.

11. The positive electrode for a secondary battery according to claim 2, wherein
the positive electrode current collector comprises foil that comprises aluminum as a main raw material therefor.

12. The positive electrode for a secondary battery according to claim 2, wherein
the positive electrode electroactive substance is
a combination of a spinel type lithium-manganese complex oxide represented by LiMn₂O₄ or the like and a lithium-nickel complex oxide represented by LiₓNi_{y}Al_{z}Co_{w}O₂;
wherein the content ratio of the spinel type lithium-manganese complex oxide to the lithium-nickel complex oxide, which are comprised in the combination; (the mass of the spinel type lithium-manganese complex oxide/the mass of the lithium-nickel complex oxide) is selected within the range of no larger than 80/20.

13. The positive electrode for a secondary battery according to claim 2, wherein
the conductive auxiliary comprises carbon.

14. The positive electrode for a secondary battery according to claim 2, wherein
the binder comprises fluorine and carbon.
